(19) United States
(12) Patent Application Publication
(10) Pub. No.: US 2012/0135234 A1
(43) Pub. Date: May 31, 2012

(54) BIODEGRADABLE NANOFIBERS AND IMPLEMENTATIONS THEREOF

(76) Inventors: Anil N. Netravali, Ithaca, NY (US); Yong Lak Joo, Ithaca, NY (US); Daehwan Cho, Ithaca, NY (US); Olivia Nnadi, Hoboken, NJ (US)

(21) Appl. No.: 13/321,267

(22) PCT Filed: May 18, 2010
(86) PCT No.: PCT/US2010/035220

§ 371 Date: Feb. 15, 2012

Related U.S. Application Data
(60) Provisional application No. 61/179,279, filed on May 18, 2009.
(60) Provisional application No. 61/318,623, filed on Mar. 29, 2010.

(51) Int. Cl. B32B 5/02; B01D 39/16; D01F 4/00; C08L 89/00; B29C 67/20; B82Y 30/00

(52) U.S. Cl. 428/401; 524/25; 264/413; 55/495; 977/773

(57) ABSTRACT

A fibrous product is described that comprises biodegradable fibers on a substrate. The fibers originate from a deposition solution that comprises a protein-based component and a carrier polymer component, each configured so that the resulting deposition solution can be deposited using electro-deposition techniques. In one embodiment, the proteins in the deposition solution are denatured in a manner that modifies the viscosity of the resulting deposition solution so that the deposition solution is compatible with electro-spinning.

### CROSS-REFERENCE TO RELATED APPLICATIONS

This application claims the benefit of priority to U.S. Provisional Patent Application Ser. No. 61/179,279 entitled “Biodegradable Nanofibers for Air Filtration and filed on May 18, 2009. This application also claims the benefit of priority to U.S. Provisional Patent Application No. 61/318,623 entitled “Biodegradable Nanofibers” and filed on Mar. 29, 2010. The content of these applications is incorporated herein by reference in their entirety.

### TECHNICAL FIELD

The present disclosure relates to fibers and fibrous products, e.g., with fibers formed by electro-deposition of a solution comprising a carrier polymer solution and a protein-based solution (e.g., having denatured proteins).

### BACKGROUND

Products created using renewable feed stocks lessen the consumption of synthetic polymeric materials that are mainly derived from fossil fuels and other non-renewable resources. Many of these polymers do not degrade under normal conditions, let alone in conditions that occur in landfills and waste repositories. Thus products made of synthetic polymer materials last for centuries.

### SUMMARY

Described herein are biodegradable fibers, their production, precursor materials used in their production, devices and equipment used in their production, fibrous products made from such fibers, methods for making such fibrous products, and devices and equipment for making such fibrous products. In some instances, the fibers are nanofibers (i.e., fibers having a diameter less than 1 micron). In some instances, the fibers comprise denatured proteins or peptides. In some instances, the fibers also comprise a non-peptidic and non-protein water soluble polymer. In some embodiments, the protein/peptide is a proteoglycan. In some instances, the fibers are produced by electrospinning.

In some instances, the fibrous products comprise a network of a biodegradable fiber described herein. In some instances, the fibrous products are used as filters. In some instances, the fibrous products are biodegradable and/or compostable. In some instances, the fiber networks of such fibrous products are sticky and/or adhere to pathogens (e.g., viruses, bacteria and components thereof). In some instances, such fibrous products are flexible and/or rollable and/or lightweight relative to other fibrous products (e.g., made with non-biodegradable and/or non-protein/peptide-containing, and/or sub-micron sized fibers).

In one embodiment, a fibrous product comprises a biodegradable substrate and a fiber network disposed on the biodegradable substrate. The fiber network comprises fibers comprising a protein-based component and a water-soluble polymer component mixed with the protein-based component to form a deposition solution. The embodiment further defined wherein the deposition solution comprises denatured proteins arising from the protein-based component.

In another embodiment, a biodegradable filtration product comprises a first layer with a biodegradable substrate and a second layer disposed on the biodegradable substrate. The second layer comprises a network of interconnecting fibers forming a plurality of openings for permitting air to pass through the second layer. The embodiment further defined wherein each of the interconnecting fibers comprises a protein-based component and a water-soluble polymer component. The biodegradable filtration product yet further defined wherein the protein-based component comprises denatured proteins.

In yet another embodiment, a deposition solution for electro-spinning fibers onto a substrate. The embodiment of the deposition solution comprises a first solution comprising a protein-based component and a second solution mixed with the first solution. The embodiment comprises a carrier component comprising a water-soluble polymer. The embodiment further defined wherein the protein-based component comprises denatured proteins.

In still another embodiment, a method comprises steps for forming a fibrous product. The embodiment of the method comprises a step for preparing a first solution comprising a soy-protein in water, a step for introducing a second solution to the first solution, the second solution comprising a water-soluble polymer in water, a step for denaturing the soy-protein, and a step for electro-spinning the resulting deposition solution onto a substrate.

In still yet another embodiment, a nano-fiber comprises a denatured protein based component and a water-soluble polymer component.

### BRIEF DESCRIPTION OF THE DRAWINGS

So that the manner in which the above recited features of the present disclosure can be understood in detail, a more particular description of the disclosure briefly summarized above, may be had by reference to the figures, some of which are illustrated and described in the accompanying appendix. It is to be noted, however, that the appended documents illustrate only typical embodiments of this disclosure and are therefore not to be considered limiting of its scope, for the disclosure may admit to other equally effective embodiments. Moreover, any drawings are not necessarily to scale, emphasis generally being placed upon illustrating the principles of certain embodiments of disclosure.

Thus, for further understanding of the nature and objects of the disclosure, references can be made to the following detailed description, read in connection with the Appendix in which:

FIG. 1 is a top view of an exemplary embodiment of a fibrous product;

FIG. 2 is a side, cross-section view of the fibrous product of FIG. 1;

FIG. 3 is a top, detail view of the fibrous product of FIG. 1;

FIG. 4 is a side, cross-section view of another exemplary embodiment of a fibrous product;

FIG. 5 is a side, cross-section view of yet another exemplary embodiment of a fibrous product;

FIG. 6 is a top view of still another exemplary embodiment of a fibrous product;

FIG. 7 is a side, cross-section view of the fibrous product of FIG. 6;

FIG. 8 is a flow diagram of an exemplary embodiment of a method for forming a fibrous product such as the fibrous product of FIGS. 1-7;

FIG. 9 is a flow diagram of another exemplary embodiment of a method for forming a fibrous product such as the fibrous product of FIGS. 1-7;

FIG. 10 is a schematic diagram of an exemplary embodiment of an electro-deposition system;

FIG. 11 is an image of another exemplary embodiment of an electro-deposition system; and

FIG. 12 is a plot of tensile test data for fibrous products such as the fibrous products made in accordance with the methods of FIGS. 8 and 9.

### DETAILED DESCRIPTION

We recognize an industrial need for materials made from renewable sources with consumers seeking more sustainable and eco-friendly products. Biodegradable polymers such as cellulose and polylactic acid (PLA), both of which can be derived from renewable resources such as cotton, corn, and potato, are examples that can be composted at the end of their useful life. Soybeans are one of the most produced crops in the world and their abundance makes them readily accessible and one of the most cost competitive feed stocks for biodegradable applications. However, while abundant in supply, compositions and materials that comprise soy-based components are generally not utilized for certain applications because of the characteristics (e.g., mechanical properties) of the resultant products.

We also recognize a need to provide protein-based biodegradable materials, and more particularly it is desirable that such protein-based biodegradable materials have mechanical properties that are compatible for use in, e.g., filters and filtration systems.

Accordingly, there is provided in the discussion below details, configurations, and processes related to embodiments of fibers and fibrous products. In some embodiments, these fibrous products are constructed in a manner that facilitates their decomposition under natural conditions as well as in a compost medium. But while many bio-degradable materials decompose, the fibrous products of certain embodiments of the present disclosure are configured so that the fibers and/or fiber network of the fibrous products also exhibit superior mechanical properties, improved filtration characteristics including efficiency, and increased capability without adversely affecting the pressure drop across, e.g., a filter media. In one example, utilization of fibers and fiber networks of the present disclosure in filter media improves pressure drop as compared to conventional filtration media and devices using, e.g., fibers composed of non-biodegradable, synthetic polymers.

By way of example, and as discussed in more detail below, we have identified combinations of components that can be mixed together to form a deposition solution that can be electro-deposited (e.g., electro-spun) to form a plurality of fibers. These fibers are useful for applications such as filtration products. Unlike synthetic and glass fibers used in conventional filtration products, however, certain fibers of the present invention are biodegradable and rendered with sufficient mechanical strength for industrial applications such as for use as the filter media mentioned above. In one embodiment, the deposition solution can comprise one or more component solutions such as a protein-based solution and a carrier polymer solution. Component solutions are optionally aqueous-based solutions with water-soluble and/or water-processable components, thus eliminating the need for and costs associated with organic solvents and other chemicals that are required to produce the synthetic fibers mentioned above. Other suitable solvents (e.g., non-toxic solvents), such as ethanol, are optionally utilized alone or in combination with water. In some embodiments, fibers and fiber products described herein are substantially free of a toxic solvent. In more specific embodiments, fibers and fiber products described herein are substantially free (e.g., less than 1% w/w, less than 0.5% w/w, less than 0.1% w/w, less than 0.01% w/w) of a solvent other than water or alcohol

In some embodiments, a fiber or protein-based solution described herein comprises a protein and/or peptidic component, which in one example is denatured so that the viscosity of the deposition solution can be used to form electro-spun fibers. Examples of the protein component can include soy-based materials such as soy-protein concentrate (“SPC”), soy flours (“SF”), and/or soy-protein isolates (“SPI”). Moreover, while the discussion below focuses in large part on SPI, the protein component can also be found in other sources of proteins such as whey, gluten, zein, albumin, and gelatin, among others. In some instances, the proteins are from any plant source or animal source. In certain embodiments, the protein component is a proteoglycan. Furthermore, any recitation of SPI herein is exemplary and can be substituted with another soy-based material (e.g., SPC) or another protein source, such as described herein.

A fiber or carrier polymer solution described herein can comprise a carrier polymer. The carrier polymer is optionally biodegradable or non-biodegradable. The carrier polymer can comprise any suitable polymer for the intended purpose of fiber. This carrier polymer can include water-soluble polymers (including, e.g., synthetic polymers) such as polyvinyl alcohol (PVA) and/or other polymers that facilitate processing an/or production of a fiber (e.g., during electro-spinning). Such polymers may also help to maintain the integrity of the protein-based component e.g., during electro-spinning. Other examples of materials suitable for use as the carrier polymer can include, but are not limited to, polyethylene oxide (PEO) and polyethylene glycol (PEG). It is further contemplated that polymers and/or polymeric materials (hereinafter “polymers”) such as those used in and/or as the carrier polymer can be substances that can comprise repeating structural units, and in one example the polymers can contain more than 100 repeating units. Polymers can also include those materials that comprise soluble and/or fusible molecules that have long chains of repeating units.

A fiber or deposition solution described herein can also comprise supplemental components or a supplemental solution. In various embodiments, such supplemental components or solutions can be used to modify aspects of the resulting deposition solution, fibers, and/or filter media. These modifications can include, for example, improvements to moisture resistance, moisture sensitivity, stiffness and tensile strength of the fibers, improved filtering efficiency, and the like. The supplemental components/solutions can comprise a variety of supplemental components such as, but not limited to fatty acids such as stearic acid, micro-scale and nano-scale particulates such as titanium oxide (TiO₂) and nano-clay, nanocrystalline cellulose (NCC), cellulose nanocrystals (CNC), nanofibrillated cellulose (NFC), and carbon-based materials such as bio-char. Still other additives can also be included that can modify one or more rheological properties of the deposition solution. Exemplary additives can comprise, for example, additives for adjusting pH such as sodium hydroxide (NaOH), surfactants such as p-tertiary-octylphenoxy polyethyl alcohol and other additives for modifying surface tension and retarding gelation of, e.g., PVA when it is used as the carrier polymer. In one embodiment, an exemplary supplemental component is an antimicrobial agent (e.g., an anti fungal, anti-viral, and/or anti-bacterial agent). In specific embodiments, the antimicrobial agent is an antimicrobial nanoparticle.

The fibers can be deposited generally randomly as a fiber network on a substrate. The fiber network can comprise a plurality of pores through which fluids (e.g., air) can pass through the fibrous product. The fiber network can be characterized in accordance with the density of these pores, the size of these pores, as well as in accordance with the distribution of the pore sizes (e.g., as related to a specified area of the filter media). The fiber network can also be characterized by the weight coverage of the fibers disposed on the substrate. By way of example, but not limitation, the weight coverage of fibers in fibrous products suitable for use as a filter media can be from about 0.2 g/m² to about 10 g/m². Although the characteristics of the fiber network can vary, fiber networks constructed in accordance with the concepts disclosed herein can capture and filter particles that are as small as about 0.1 μm. Moreover, materials compatible with one or more of the components in the deposition solution can improve performance of the resultant fibrous product by also inhibiting and/or capturing smaller particulates, microbes, and biological organisms such as those on the scale of viruses (e.g., about 0.1 μm).

In certain embodiments, a fiber or deposition solution described herein comprises a protein-based component and a carrier polymer (e.g., a water-soluble polymer) in a ratio of protein-based component to carrier polymer component of less than 99:1, or less than 98:2, or 0.001:1 to 99:1, or less than 1:1, or less than 2:1, or less than 3:1, or less than 4:1, or less than 5:1, or less than 10:1, or less than 20:1, or 0.01:1 to 1:1.

In some embodiments, a fiber described herein has any suitable diameter, e.g., has an average diameter of the nanofiber is less than 200 nm, less than 150 nm, less than 80 nm, less than 10 microns, less than 5 microns, 300 nm to 1 micron, 350 nm to 10 microns, 350 nm to 5 microns, or the like. In certain embodiments, a fiber described herein has an elemental nitrogen percentage of between 0.1% and 9% relative weight, between 0.1% and 6% relative weight, between 1% and 6% relative weight, between 2% and 5% relative weight, about 3% relative weight, or the like.

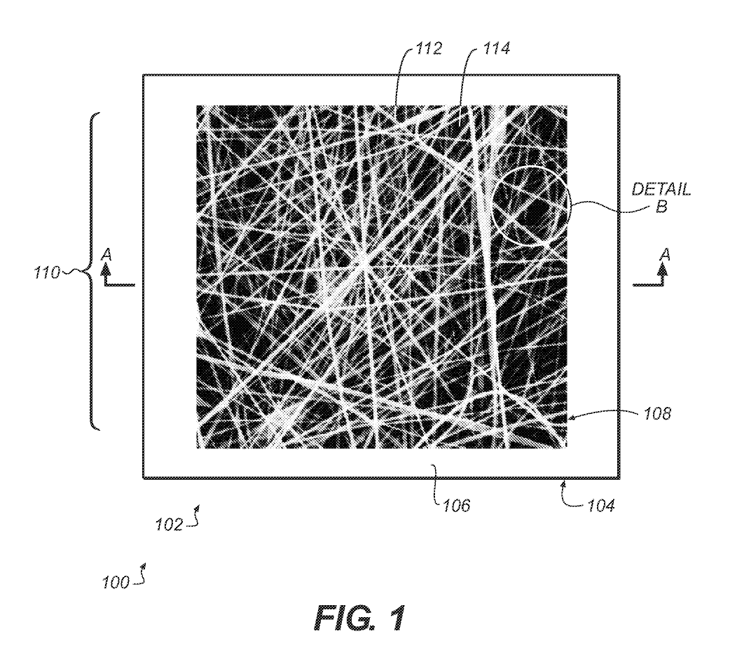

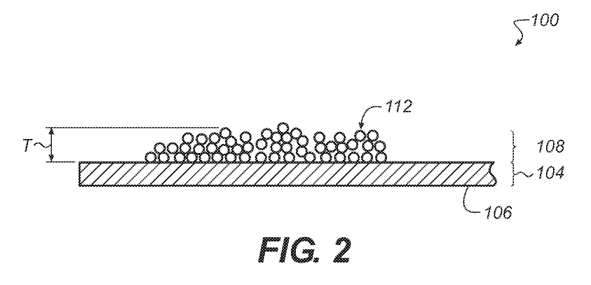

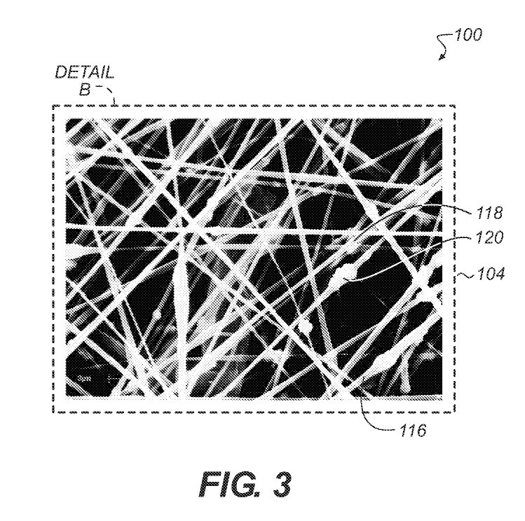

Referring now to the drawings, and for further discussion of the concepts briefly described above, there is illustrated in FIGS. 1-3 an exemplary embodiment of a fibrous product 100. The fibrous product 100 can comprise a multi-layer structure 102 formed with a first layer 104 such as a substrate 106 and a second layer 108 disposed on the substrate 106. The second layer 108 can comprise a fiber network 110 that has plurality of fibers 112 dispersed to form pores 114. Each of the fibers 112 can comprise a fiber morphology 116, and in the present example the fiber morphology 116 can comprise one or more fiber nodules 118 formed about a particle 120 such as the titanium oxide nano-particles mentioned above.

The multi-layered structure 102 can be constructed in accordance with the implementation selected for the fibrous product 100. Filtration, purification, and related implementations may require, for example, that the multi-layered structure 102 include layers of material in addition to the first layer 104 and the second layer 106. These layers may be biodegradable, or in one embodiment one or both of the first layer 104 and the second layer 106 may be removable from these additional layers for purposes of disposal. The non-disposed of material layers can be configured to be recycled such as by receiving new layers (e.g., the first layer 104 and the second layer 108) disposed thereon. Other implementations may likewise necessitate supportive components such as an outer frame (not shown), which may permit the fibrous product 100 to be installed in, e.g., a filtration system. Construction including sizing by cutting of the fibrous product 100 for such supportive components can be done during manufacturing, or as one or more processes that are secondary to the manufacturing of the fibrous product 100.

In one embodiment, the substrate 106 supports the second layer 108, and more particularly can provide a suitable platform upon which the fiber network 110 can be deposited by, e.g., electro-spinning. Substrates of the type for use as the substrate 106 are generally compatible with the processes for depositing the fibers 112. These substrates can be chosen for their chemical and physical properties such as their compatibility with the implementation of the fibrous product 100. For purposes of scale-up and production capabilities the material for the substrate 106 may also be provided in bulk or bulk-type quantities so as to permit continuous production capabilities. Examples of these materials can include biodegradable and decomposable materials, and in one particular construction the first layer 102 comprises cellulose-based materials such as paper (e.g., paper towels and commercially available filters including thin filters) and related wood-pulp products.

The second layer 108 can be defined by various dimensions including a thickness T, the value of which can be controlled by the deposition technique employed during manufacturing. Typically the thickness T defines the average thickness of the fibrous network 110 over the surface of the substrate 106. While it is recognized that this average thickness can vary due to process and/or production factors, it may be generally desirable that values for the thickness T fall within a range of about 0.5 mm to about 10 mm, with the thickness T in one construction of the fibrous product 100 being from about 3 mm to about 5 mm.

The fibers 112 can be randomly deposited to form the fiber network 110. Deposition can be controlled in accordance with operative parameters of the selected electro-deposition technique. The random deposition can lead to varying cross-sections and dimensions of the fibers 112. The cross-sections can be generally circular. However, other cross-sections as between individual fibers 112 in the fiber network 100, as well as along a single fiber 112, can also include elliptical and oblong cross-sections as may occur during deposition onto the substrate 106. Fibers of the type contemplated herein can have an average diameter of less than about 0.3 μm, and in one particular construction of the fibrous product the average diameter can vary from about 0.1 μm to about 0.5 μm. Incorporation of the particles 120 into the deposition mixture can also cause other variations in the cross-section of the fibers 112. These variations can manifest themselves in one example as the fiber nodules 118. The extent to which the fiber nodules 118 are found along the fibers 112 can be controlled by the loading or concentration of the particles 120 that are found in the deposition solution.

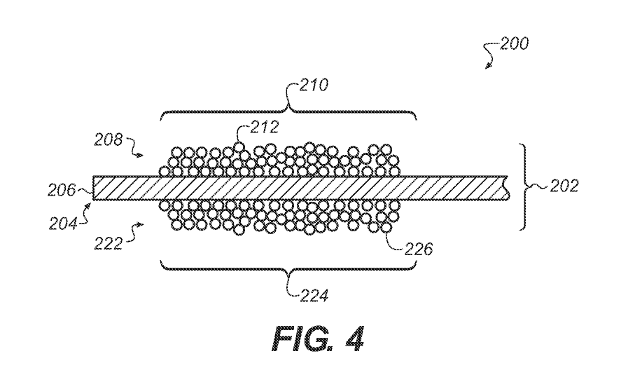

Configurations and construction of the multi-layered structure 102 can vary such as by providing more or less of the layers (e.g., layers 104 and/or layers 108), substrates (e.g., substrate 206), and the like. By way of example, and for additional embodiments of fibrous products constructed in accordance with such concepts, reference can now be had to FIGS. 4-7. Like numbers are used to identify like components as between the embodiment in FIG. 1 and those illustrated in FIGS. 4-7, except those numerals are increased by 100 (e.g., 100 is now 200 in FIG. 4). Moreover, and in view of the foregoing discussion of the fibrous product 100 of FIG. 1 above, there is provided examples of fibrous products (e.g., fibrous products 200, 300, and 400) that are also suited for use as, e.g., filter and filtration media.

In FIG. 4, for example, there is illustrated a fibrous product 200 that has a multi-layered structure 202 that includes a first layer 204, which includes a substrate 206, and a second layer 208. The multi-layered structure 202 also includes a third layer 222, which in the present configuration includes a fiber network 224 that has plurality of fibers 226. The fibers of the third layer 222 can be materially and morphologically the same as the fibers that comprise other layers such as the second layer 208 of the multi-layered structure 202. On the other hand, and based for example on the desired implementation or characteristics (e.g., pressure drop), the fibers of the various layers of the multi-layer structure 202 can vary as desired.

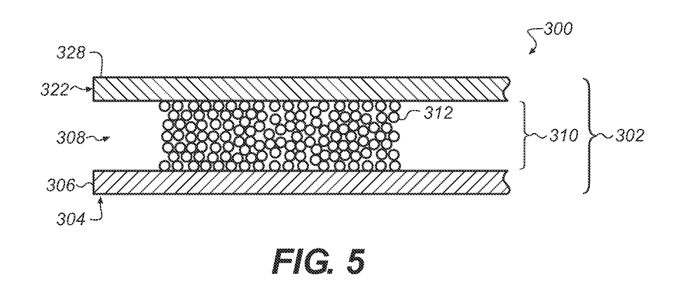

There is depicted in FIG. 5 a fibrous product 300, constructed of a multi-layered structure 302, in which there is provided a first layer 304 comprising a substrate 306, a second layer 308 that is configured with fibers as discussed herein. The multi-layered structure 302 also includes a third layer 322. But in comparison to the third layer 222 of FIG. 4 above, the third layer 322 in the present example can comprise a substrate 328. In one example, the substrate 328 can have the same properties and construction as the substrate 306. In another example, the substrate 328 can comprise materials, formations, and other physical and chemical characteristics that are different from the substrate 306.

Also contemplated in and among the various embodiments of fibrous products and filter media discussed herein above are constructions and configurations that include other materials. These materials can be disposed in, around, on top of, or otherwise in communication with, e.g., portions of the multi-layer structure. These materials may not necessarily be derived from the deposition solution in particular, but rather may be added as additional components such as to enhance or enable structural and physical aspects of the resulting filter media.

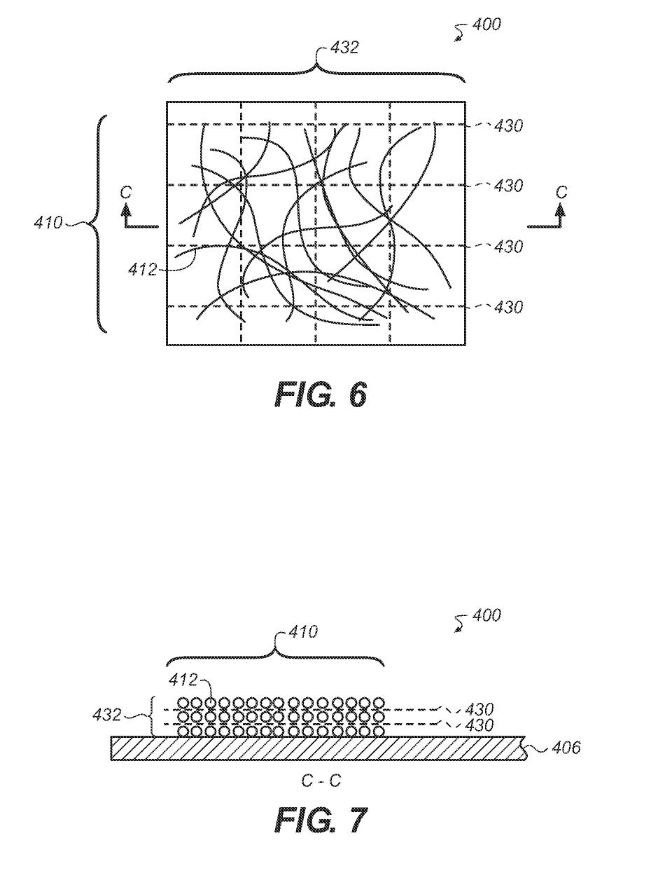

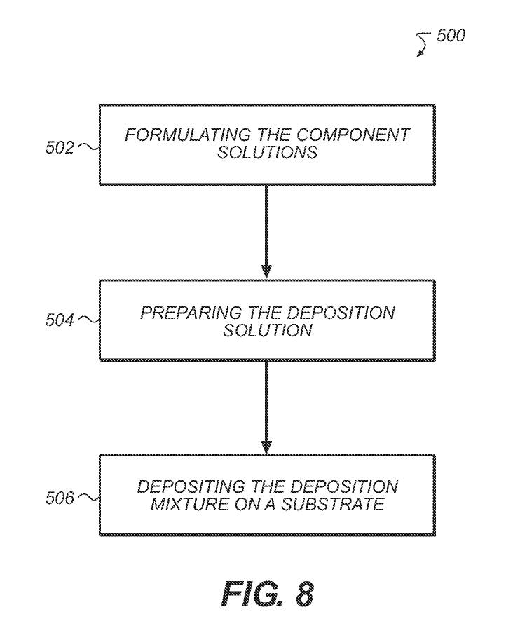

In one embodiment, illustrated as the exemplary embodiment of a fibrous product 400 of FIGS. 6 and 7, the fibrous product 400 can comprise structural strands 430 such as filaments, yarns, and fabric material, all of which can comprise biodegradable material such as cellulose. The structural strands 430 can form a structural network 432 that can improve the stiffness, strength, and other physical characteristics of the fibrous product 400 as desired. In one example, the structural strands 430 can be incorporated into the fibrous product, with the particular construction of FIGS. 6 and 7 illustrating structural strands 430 woven (or interdispersed) into the fiber network 410 of one more layers of the multi-layered structure 402. Materials for use as the structural strands 430 can include biodegradable and non-biodegradable materials. Moreover, construction of the individual structural strands 430, as well as their implementation into the fibrous product 400 can vary as per the implementation and/or the desired characteristics (e.g., pressure drop) of the resulting fibrous product 400 and/or filter and filtration media. Still other embodiments of the fibrous product 400 are contemplated wherein the structural strands 430 are incorporated in the substrate 406.

Referring next to FIG. 8, there is illustrated an exemplary embodiment of a method 200 for forming the fibrous product such as the fibrous products of FIGS. 1-7. Methods such as method 500 can include a variety of steps 502-506, which are useful for the preparation and deposition of the deposition solution. One or more of these steps can be implemented to modify the apparent shear viscosity of the deposition solution such as by causing denaturing or dissolution of the proteins associated with the protein component in the deposition solution. Suitable viscosity for the deposition solution can be from about 0.1 Pa*s to about 1000 Pa*s, and in one embodiment the viscosity of the deposition solution is from about 1 Pa*s to about 10 Pa*s.

Method 500 can comprise at step 502 formulating the component solutions, at step 504 preparing the deposition mixture, and at step 506 depositing the deposition mixture on a substrate. Each of the component solutions can be prepared separately before being mixed together to form the deposition solution. Water can be used to dissolve the respective components, e.g., the protein-based component and the carrier polymer. In one embodiment, the percentage of the protein-based component in the deposition solution does not exceed about 50%. More particular embodiments, however, may be configured so that the percentage of the protein-based component in the deposition solution is from about 10% to about 100%.

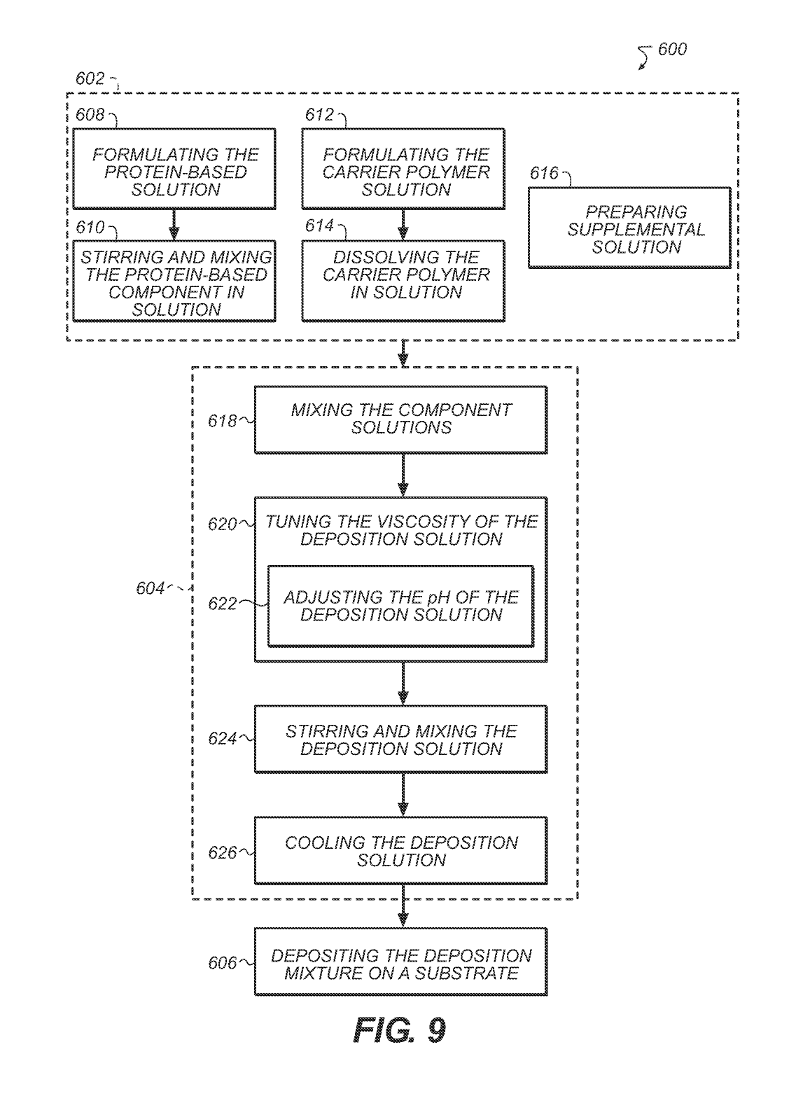

FIG. 9 illustrates another exemplary embodiment of a method 600 for forming the fibrous product. As discussed in connection with FIG. 8 above, the method 600 can comprise at step 602 formulating the component solutions, at step 304 preparing the deposition mixture, and at step 606 depositing the deposition mixture on a substrate. Particular to the embodiment of FIG. 9, however, there is provided a step 608 for formulating the protein-based solution, which can comprise one or more steps 610 for stirring and mixing the protein-based component in solution. The method 600 also comprises a step 612 for formulating the carrier polymer solution that includes a step 614 for dissolving the carrier polymer component in solution. The method 600 can also comprise a step 616 for preparing the supplemental solution such as would occur when nanoparticles and/or other supplemental components are added to the deposition solution.

The method 600 also comprise at step 618 mixing the component solutions together, in this case the protein-based solution and the carrier polymer solution, to form the deposition solution. By way of example, the method 600 comprises a step 620 for tuning the viscosity of the deposition solution such as by, at step 622, adjusting the pH level of the deposition solution. The method 600 further includes one or more steps 624 for stirring and mixing the deposition solution, as well as a step 626 for cooling the deposition solution before the deposition solution is, e.g., deposited on the substrate (step 606).

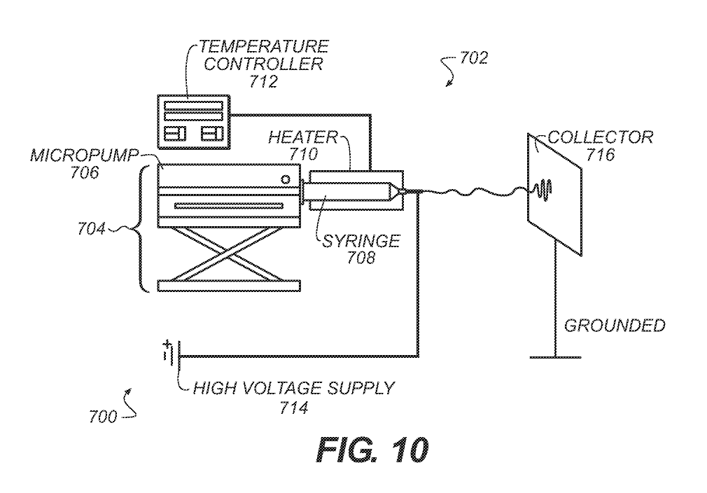

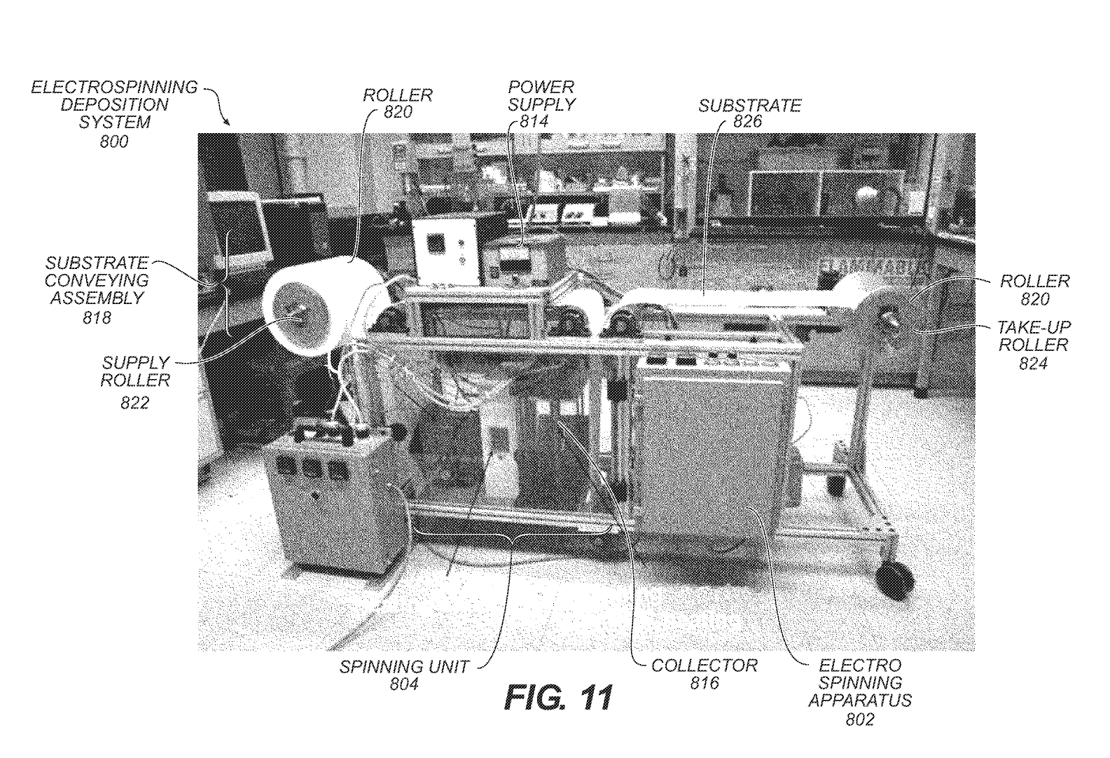

Referring now to FIGS. 10 and 11, deposition of the substrate can be facilitated using electro-deposition systems such as one of the exemplary electro-spinning deposition systems 700 and 800 discussed below. In FIG. 10, there is shown an embodiment of an electro-spinning deposition system 700 that can comprise an electro-spinning apparatus 702. The electro-spinning apparatus 702 can comprise a spinning unit 704, in which there is incorporated a micropump 706, a syringe 708, and a heater 710. The electro-spinning apparatus 702 can also comprise a temperature controller 712, which is coupled to the heater 710, and a power supply 714 that is coupled to the syringe 708 so as to cause a voltage at the tip of the syringe 708. A collector 716 such as a grounded metallic plate or metallic roller is also provided and on which is deposited the deposition solution in the form of the fibers disclosed and described herein.

FIG. 11 is another exemplary embodiment of an electro-spinning deposition system 800. Where applicable like numerals are used to identify like components as between FIGS. 10 and 11 but the numerals are increased by 100 (e.g., 700 is now 800 in FIG. 11). By way of example, the electro-spinning deposition system 800 can also comprise an electro-spinning apparatus 802 that, as discussed in connection with system 700 of FIG. 10, can include with a spinning unit 804, a power supply 814, and a collector 816. Other features such as those features discussed in connection with FIG. 10 above, but not illustrated in the present diagram of FIG. 11, can be likewise incorporated into the electro-spinning deposition system 800.

Particular to the present example, the electro-spinning deposition system 800 can also comprise a substrate conveying assembly 818, which can be useful for scale-up and production capabilities in accordance with the concepts herein. The substrate conveying assembly 818 can comprise rollers 820 such as a supply roller 822 and a take-up roller 824, both of which work in conjunction to convey a substrate 826 through the electro-spinning apparatus 802. Not shown but also considered are various ancillary devices such as motors, gears, belts, and control devices that may be useful or necessary to produce fibrous products of the type described herein in an automated fashion such as by incorporating automated devices (e.g., robots) and related control structure.

Fibers and fibrous products described herein exhibit a variety of advantageous properties, some of which include:

Optionally, the fibers and fibrous products described herein are biodegradable (e.g., compostable). For example, the fibers and fibrous products described herein are composed of denatured proteins/peptides and water soluble non-protein/peptide polymers. When such materials are subjected to composting conditions, such materials degrade. However, when not subjected to composting conditions, such materials do not degrade or degrade in such negligible amounts, that the utility of such materials is not compromised.

Optionally, the fibers and fibrous products described herein are sticky (i.e., adhere to) to pathogenic materials. Such pathogenic materials include, but are not limited to, viruses, prions, bacteria, fungi, components of such pathogens, and the like. That is, when the fibers described herein are woven into a fiber network to form a fibrous product, one use of such fibrous products is in the form of filter materials. Such filter materials allow gases to pass through. However, unlike prior art fibrous materials, the fibers described herein are sticky, and as a result the fibrous products not only limit the passage of materials based on the pore size of the fiber network, but also limit the passage of materials smaller than the pore size of the fiber network. The fibrous products achieve this latter advantage, e.g., because of the stickiness of the fibers of the fiber network. As a result, e.g., particles smaller than the pore size of the fiber network (e.g., pathogens) are prevented from passing through the fiber network. Such stickiness arises, e.g., from the composition of the protein/peptide portion of the fibers. Such stickiness is optionally tuned, e.g., by modifying the components of the protein/peptide portion of the fibers that provide the adherent properties. In some embodiments, the aforenoted portion are the charged amino acids of the protein/peptide and/or the post-translational modifications of the protein/peptide (e.g., glycans, including e.g., sialic acid groups). In one optional embodiment, the ‘sticky’ portions of the fibers are covalently bound to the fibers, but in other embodiments, the ‘sticky’ portions of the fibers are not-covalently bound to the fibers.

Optionally, the fibers and fibrous products described herein have a large surface area. In some embodiments, a large surface area is a function of the diameter, and/or fiber coverage density, and/or weave of the fiber. In some embodiments, the filtration efficiency increases as the fiber density coverage increases.

Optionally, the fibers and fibrous products described herein have an improved tensile strength relative to non-protein/peptide relative to non-protein/peptide containing fibers and fibrous products. In some embodiments, the tensile properties of the fibers and fibrous products is a function of the pH of the denaturing solution, e.g., at more extreme pH values (acidic or basic), the protein/peptide is damaged, leading to lower tensile properties.

Optionally, the fibers and fibrous products described herein are identified by the presence of nitrogen. In general, because the fibers and fibrous products contain denatured proteins/peptides, the fibers and fibrous products are characterized by the presence of nitrogen, in addition to carbon, hydrogen and oxygen. This property is optionally used to identify the provenance/origin of a fibrous product and to distinguish the fibrous products described herein from non-protein/peptide based fibers.

Optionally, the fibrous products described herein are flexible and/or rollable relative to non-protein/peptide containing fibrous products. As a result, such fibrous products are optionally stored in the form of rolls and/or other packed fibrous products. As needed, such rolled/packed fibrous products are used simply by unrolling/unpacking the fibrous products as needed.

Optionally, the fibrous products described herein do not contain detectable amounts of non-aqueous or non-ethanolic solvents. The fibrous products described herein do not require non-aqueous or non-ethanolic solvents for production. As a result, and in distinction to prior art materials, the resulting fibrous products do not contain detectable amounts of non-aqueous or non-ethanolic solvents (including benzene, toluene, methanol, methylene chloride, formic acid, formaldehyde, chloroform and chlorobenzene).

For further clarification, instruction, and description of the concepts above, embodiments of the present invention are now illustrated and discussed in connection with the following examples:

### Example I

A deposition solution can be formulated with a protein-based solution and a carrier polymer solution. The carrier polymer solution can comprise a PVA powder (e.g., PVA powder with a molecular weight of 78,000 manufactured by Sigma Aldrich of St. Louis, Mo.) that is dissolved in water so that the concentration of PVA powder is less than about 15%. The water can have a water temperature from about 50° C. and about 90° C. During preparation the PVA powder can be dissolved in the water for between about 0.25 hours and 3 hours.

The protein-based solution can comprise an SPI powder (e.g., PRO FAM 0 manufactured by Archer Daniels Midland Co. of Decatur, Ill.) that is dissolved in water so that the concentration of SPI powder is less than about 8.5%. The water can have a water temperature from about 70° C. to about 95° C. During preparation the SPI powder can be stirred in water for about 10 min to about 60 min.

The component solutions thus prepared can be combined to form the deposition solution, wherein the total material concentration (e.g., the material concentration of SPI and PVA) for the deposition solution can be from about 5 wt % to about 20 wt %. An amount of a first additive can be added to the deposition solution to raise the pH of the deposition solution above neutral (e.g., pH 7). An amount of a second additive such as a surfactant (e.g., Triton X-100 manufactured by Sigma Aldrich of St. Louis, Mo.) can be added to the deposition solution. This amount can be from about 0.02 wt % to about 0.1 wt % of the basis volume of the deposition solution. The resulting deposition solution can thereafter be heated to a temperature from about 25° C. to about 90° C. and/or mixed for about 10 min to about 30 min.

### Example II

The PVA powder and the SPI powder of EXAMPLE I are used to form a deposition solution. In this example, the carrier polymer solution comprises the PVA powder, which is dissolved in water for about 4 hours, wherein the water temperature is about 95° C. The protein-based solution comprises the SPI powder, which is dispersed in water at about room temperature (e.g., from about 20° C. to about 25° C.) and stirred for about 5 min to about 10 min.

The protein-based solution and the carrier polymer solution are mixed to form the deposition solution. Sodium hydroxide is added to the deposition solution in an amount sufficient so that the pH of the deposition solution varies from about 8 to about 12. Triton X-100 is added so that the surfactant concentration is about 0.5% on the basis of the volume of the deposition solution. The deposition solution is thereafter heated to about 80° C. and mixed for about 10 min.

The deposition solution can be deposited onto a substrate using an electro-deposition assembly such as the electro-spinning assembly illustrated in FIGS. 10 and 11. In this EXAMPLE II, a 5 cc plastic syringe with an 18 gauge needle (with an inner diameter of about 0.84 mm) was loaded with the deposition solution. The high-voltage power supply was used to apply the positive charge to the needle. The collector was grounded. The micro-pump was used to infuse the solution and to eject it towards the collector. A voltage of 15 kV was maintained at the tip of the needle. The distance between the collector and the needle tip was about 15 cm. The flow rate of the solution was set to about 0.9 ml/hour.

### Example III

Filtration efficiency testing of fibrous product specimens was measured using a Multi-Channel Particle Test Media device. In one example, particles with diameters ranging from about 0.1 μm to about 2 μm were generated using potassium chloride (KCL) solution. The particles were mixed with air, and are introduced to the specimen at a velocity of 0.24 m/s. Counting of the particles occurs at both upstream and downstream locations of the specimen using a laser particle counter. The upstream concentration across specimen was measured for about 3 minutes. The filtration efficiency was calculated in accordance with Equations 1 and 2 below,

$$\begin{matrix}Filter Efficiency = 1 - P ( i ) , wherein & Equation ( 1 ) \\ P ( i ) = \frac{a ( i )}{b ( i )} , & Equation ( 2 )\end{matrix}$$

further wherein P(i) is the penetration of i μm sized particles, a(i) is the particle concentration after the filter for i μm sized particles, and b(i) is the particle concentration before the filter for i μm sized particles.

Several fibrous product specimens were prepared by electro-spinning the deposition solution of EXAMPLE II into fibers on the surface of a substrate (e.g., a bare filter composed of cellulose fibers). Square pieces of bare filter (dimensions 7.5 cm×7.5 cm) were used as the substrate. The fibers were deposited on the bare filter so as to obtain specimens in which the weight coverage of the fibers was about 1.2 g/m² and about 2.4 g/m².

Tables 1-2 below summarize the Filtration Efficiency for each of the fibrous product specimens.

TABLE 1

| | | | Weight | % Efficiency for Particle Size (μm) | | | | | | |
|---|---|---|---|---|---|---|---|---|---|---|
| Specimen | % SPI | pH | (g/m\hat{ }2) | 0.1 | 0.2 | 0.3 | 0.5 | 0.7 | 1 | 2 |
| 1 | 0 | 7 | 2.4 | 68 | 75 | 79 | 82 | 84 | 85 | 87 |
| 2 | 0 | 7 | 1.2 | 55 | 59 | 62 | 70 | 75 | 80 | 80 |
| 3 | 0 | 0 | 0 | 5 | 5 | 6 | 15 | 17 | 20 | 38 |

TABLE 2

| Spec- | % | | Weight | % Efficiency for Particle Size (μm) | | | | | | |
|---|---|---|---|---|---|---|---|---|---|---|
| imen | SPI | pH | (g/m\hat{ }2) | 0.1 | 0.2 | 0.3 | 0.5 | 0.7 | 1 | 2 |
| 1 | 15 | 9 | 1.2 | 65 | 73 | 78 | 84 | 88 | 93 | 97 |
| 2 | 15 | 12 | 1.2 | 68 | 73 | 78 | 83 | 89 | 96 | 98 |
| 3 | 35 | 9 | 1.2 | 58 | 68 | 73 | 78 | 84 | 90 | 95 |
| 4 | 35 | 12 | 1.2 | 62 | 68 | 73 | 78 | 82 | 86 | 89 |
| 5 | 50 | 9 | 1.2 | 48 | 55 | 63 | 70 | 75 | 82 | 90 |
| 6 | 50 | 12 | 1.2 | 56 | 63 | 68 | 74 | 80 | 86 | 89 |

### Example IV

Composting medium was prepared by blending sawdust and chicken manure in a ratio of 1:1 (wt/wt) with a C/N ratio of 50/50. A small plastic container, which contained a prepared fibrous product specimen, was placed in side another big plastic container. The small plastic container has circular holes on its wall for air circulation. Conditions inside the composing unit were maintained at a temperature of about 25+5° C. and a high humidity of 75±5%.

Several fibrous product specimens were prepared by electro-spinning the deposition solution of EXAMPLE II into fibers on the surface of a substrate (e.g., a bare filter composed of cellulose fibers). Each of the fibrous product specimens were measured after drying the specimen in a vacuum oven for about 24 hours. The specimens were placed in non-woven, non-degradable polypropylene bags with high porosity. The bags containing the specimens were inserted inside of the compost medium and the specimens allowed to compost for up to about 26 days. The weight of each specimen was measured as a function of time during compositing.

For purposes of EXAMPLE IV, all specimens were dried in a vacuum for about 24 hours at about 20° C. to about 25° C. Four specimens were composted for each condition. Average values were calculated.

Table 3 below summarizes the Weight Loss of the fibrous product specimens.

TABLE 3

| | | | | % Weight Retention | | | |
|---|---|---|---|---|---|---|---|
| | | | | Rate (days) | | | |
| Specimen | % SPI | pH | Weight (g/m\hat{ }2) | 1 | 2 | 8 | 26 |
| 1 | 0 | 7 | 50 | 99 | 97 | 96 | 95 |
| 2 | 25 | 12 | 50 | 90 | 88 | 85 | 78 |
| 3 | 50 | 12 | 50 | 78 | 60 | 65 | 45 |

### Example V

Mechanical testing of fibrous product specimens was performed using TA Instruments DMA Q800, which can be used to test fine strength and elongation. Specimens were clamped in the jaws and preloaded to 0.01 N to remove any initial crimping and other deviations in the fibrous product specimens. A ramping force of 0.6 N/min was applied to each of the specimens until the specimen was broken.

Several fibrous product specimens were prepared by electro-spinning the deposition solution of EXAMPLE II into fibers on the surface of a substrate (e.g., a bare filter composed of cellulose fibers). For purposes of this example the fibrous product specimens were electro-spun onto aluminum foil disposed on a long round bar having diameter of about 10 cm. The bar was rotated at about 120 RPM. An opening of about 4 mm in the aluminum foil was provided from which arose the fibers for the fibrous product specimens of the present example. Electrospinning was conducted for about 1 hour.

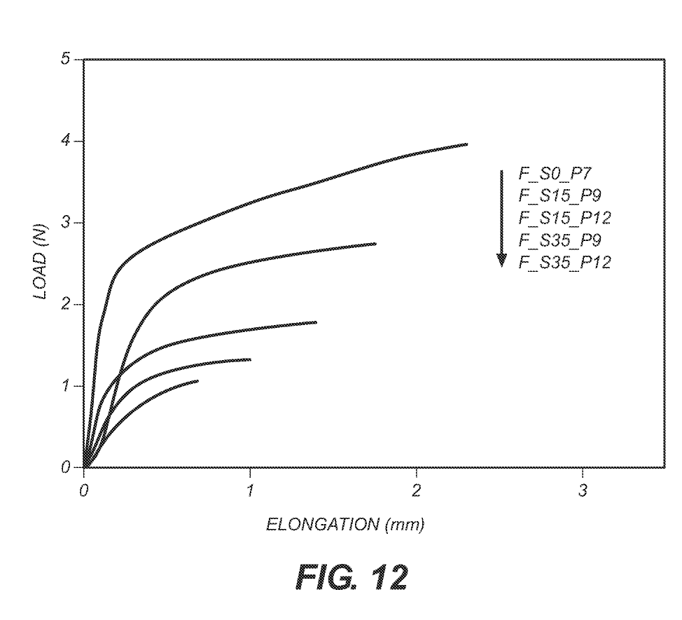

Table 4 below and FIG. 12 summarize, respectively, the Average Force/Elongation at Breaking and the Strength v. Elongation for each of the fibrous product specimens.

TABLE 4

| | | | | At Breaking | |
|---|---|---|---|---|---|
| Specimen | % SPI | pH | Weight (g/m\hat{ }2) | Load (N) | Elongation (mm) |
| 1 | 0 | 7 | 50 | 3 | 2 |
| 2 | 15 | 9 | 50 | 2.5 | 1.75 |
| 3 | 15 | 12 | 50 | 1.5 | 1.5 |
| 4 | 35 | 9 | 50 | 1.25 | 1 |
| 5 | 35 | 12 | 50 | 1 | 0.75 |

### Example VI

Characterization of fibrous product specimens such as for fiber diameter (i.e., thickness) was observed using a scanning electron microscope (SEM) such as a Lieca 440 in combination with image analysis software such as ImageJ 1.41. A median filter was used to enhance the image quality and to remove noise. A bright/contrast algorithm was applied to enhance the image. The image was thereafter converted to a binary image, e.g., wherein the image had only black and white colors. Fiber coverage density was calculated as the summation of all fiber areas over the total area in pixel units.

Table 5 below summarizes the Fiber Diameter.

TABLE 5

| Specimen | % SPI | pH | Avg. Fiber Diameter (μm) |
|---|---|---|---|
| 1 | 0 | 7 | 0.6 |
| 2 | 15 | 9 | 0.75 |
| 3 | 15 | 12 | 0.75 |
| 4 | 35 | 9 | 0.65 |
| 5 | 35 | 12 | 0.5 |

### Example VII

Other characteristics of fibrous product specimens such as those discussed in connection with EXAMPLES I-VI above also include adhesion between the electrospun fibers and the bare filter material. Adhesion can be quantitatively determined by detaching fiber mats formed of fibers such by electro-spinning the deposition solution of EXAMPLE II into fibers on the surface of a substrate (e.g., a bare filter composed of cellulose fibers). In one example, the resulting fiber mats from both solutions of pure PVA and low SPI ratio could be easily peeled off by a pincette. In another example, adhesion improved when the ratio of SPI was increased.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

While the present disclosure has been particularly shown and described with reference to certain exemplary embodiments, it will be understood by one skilled in the art that various changes in detail may be effected therein without departing from the spirit and scope of the disclosure as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A fibrous product comprising:
a biodegradable substrate; and
a fiber network disposed on the biodegradable substrate, the fiber network comprising fibers comprising a protein-based component and a water-soluble polymer component mixed with the protein-based component to form a deposition solution,
wherein the deposition solution comprises denatured proteins arising from the protein-based component.

2. A fibrous product according to claim 1, wherein the protein-based component comprises soy-based material.

3. A fibrous product according to claim 1, wherein the water-soluble polymer comprise polyvinyl alcohol.

4. A fibrous product according to claim 1, wherein the protein-based component comprises one or more of the group consisting of soy-protein isolate, soy-protein concentrate, and soy flour.

5. A fibrous product according to claim 1, wherein the fibers comprise a plurality of nano-particles.

6. A fibrous product according to claim 1, wherein the fibers comprise titanium oxide particulates.

7. A biodegradable filtration product comprising:
a first layer with a biodegradable substrate; and
a second layer disposed on the biodegradable substrate, the second layer comprising a network of interconnecting fibers forming a plurality of openings for permitting air to pass through the second layer,
wherein each of the interconnecting fibers comprise a protein-based component and a water-soluable polymer component, and
wherein the protein-based component comprises denatured proteins.

8. A deposition solution for electro-spinning fibers onto a substrate, said deposition solution comprising:
a first solution comprising a protein-based component; and
a second solution mixed with the first solution, the second solution comprising a carrier component comprising a water-soluble polymer,
wherein the protein-based component comprises denatured proteins.

9. A deposition solution according to claim 8 further comprising titanium oxide nano-particulates.

10. A deposition solution according to claim 8 further comprising a surfactant.

11. A deposition solution according to claim 8, wherein the pH is from about 8 to about 12.

12. A deposition solution according to claim 8, wherein the weight percentage of the protein-based component does not exceed 50%.

13. A deposition solution according to claim 8 wherein the viscosity of said deposition solution is from about 0.1 Pa*s to about 10 Pa*s.

14. A deposition solution according to claim 8, wherein the protein-based component comprises one or more of soy-protein isolate, soy-protein concentrate, and soy flour.

15. A deposition solution according to claim 14, herein the water-soluble polymer comprises polyvinyl alcohol.

16. A method for forming a fibrous product comprising:
preparing a first solution comprising a soy-protein in water;
introducing a second solution to the first solution, the second solution comprising a water-soluble polymer in water;
denaturing the soy-protein; and
electro-spinning the resulting deposition solution onto a substrate.

17. A method according to claim 16 further comprising adjusting the pH of one or more of the first solution and the second solution to a value from about 8 to about 12.

18. A method according to claim 16 further comprising mixing one or more supplemental components with one or more of the first solution and the second solution.

19. A method according to claim 16, wherein the total material concentration of the soy-protein component and the water-soluble polymer in the resulting deposition solution comprises at least about 10% wt of the basis volume of the resulting deposition solution.

20. A method according to claim 16, wherein the weight percentage of the soy-protein in the first solution does not exceed 8.5%.

21. A nano-fiber comprising a denatured protein based component and a water-soluble polymer component.

22. A nano-fiber according to claim 21, wherein the ratio of protein-based component to water-soluble polymer component is about 0.01:1 to about 1:1.

23. A nano-fiber according to claim 21, wherein the average diameter of the nanofiber is less than about 200 nm.

24. A nano-fiber according to claim 21, wherein the average diameter of the nanofiber is about 300 nm to about 1 micron.

25. A nano-fiber according to claim 21, wherein the protein based component is a proteoglycan.
